(19) United States
(12) Patent Application Publication
(10) Pub. No.: US 2004/0091712 A1
(43) Pub. Date: May 13, 2004

(54) Surface-coated glass granulate

(76) Inventor: Heinz Marohn, Krefeld (DE)

Correspondence Address: AKERMAN SENTERFITT, P.O. BOX 3188, WEST PALM BEACH, FL, 33402-3188, US

(21) Appl. No.: 10/473,376

(22) PCT Filed: Mar. 25, 2002
(86) PCT No.: PCT/DE02/01069

(30) Foreign Application Priority Data
Mar. 27, 2001 (DE) 101 15 159.4

(51) Int. Cl. B32B 17/10

(52) U.S. Cl. 428/417; 428/426

(57) ABSTRACT

The invention relates to a glass granulate, whose surface is coated with a protective layer. Said protective layer contains at least one organic silicon compound, at least one duroplastic and at least one inorganic polymer matrix.

The invention relates to granulated glass that is superficially coated with a protective layer and to building material structures and coverings containing said granulated glass.

It is known to add, as an optical element, metallized granulated glass, made of special glass or silicate glass, to predominantly inorganic joining aggregates. It is further current practice to bind granulated glass of various origin with reaction resin and to manufacture therefrom, among others, plates and boards for coverings and panellings.

A disadvantage in employing granulated glass, more specifically made of silicate glass, as an aggregate and an optical element is that it exhibits poor fracture toughness subsequent to granulation and poor alkali resistance which, in inorganic joining materials, leads to signs of dissolution or of expansion.

The poor fracture toughness of granulated glass made from current alkaline silicate glass is due to extremely fine microcracks that occur during manufacturing. These microcracks constitute lines of weakness in the micrometer range and soon cause the various glass particles to break apart (to crumble apart) under mechanical load. This existing instability of the granulated glass may even increase when water condenses in the microcracks, allowing the cracks to spread in the various glass grains. The formation of cracks also results in the formation of sharp edges, which may lead to injuries.

Due to its mechanical instability and poor fracture toughness, granulated glass cannot be used as a material or a building material in fields in which increased demands are placed on security and mechanical stability. This more specifically applies to floor coverings.

Another disadvantage of granulated glass made of current alkaline silicate glass is its poor resistance to caustic solutions which dissolve the silicon dioxide of the glass, removing it therefrom in the process. As a result, the use of granulated glass as an aggregate to materials joined by a hydraulic bonding system is greatly restricted. The alkaline milieu in the concrete at the glass-concrete interfaces results in the glass grain surface being attacked and dissolved. Disadvantageous cracks and stresses will then form in the concrete, and discrete glass particles located on the top surface of a concrete containing covering, more specifically a floor covering, will even detach therefrom.

A concrete containing covering that consists of a mixture of cement, aggregates and granulated optical elements made from a glass that has been vacuum metallized using high vacuum is known from DE 41 20 764 A1.

Further, artificial resin based floor coverings that contain granulated, specially tempered “Morano” glass are known. With a Moh's hardness of about 7.0, this glass has a fracture toughness that makes it suited for use in floor coverings. The cost involved in the manufacturing of this special glass is however disadvantageous.

Finally, it is known to provide window or vehicle glass panes with a silane coating in order to enhance adherence to plastic materials or metals. This process is generally called silanation.

It is the object of the invention to provide a granulated glass that has a high fracture toughness, good mechanical stability and high resistance to caustic solutions. The granulated glass is intended to be utilized as a shatterproof aggregate in floor coverings made of concrete or asphalt. Finally, the granulated glass is intended to be manufacturable at a low cost and of an aesthetic design.

The solution to this object is achieved in accordance with the invention by providing a granulated glass that is superficially coated with a protective layer, said protective layer consisting, according to need, of at least one organic silicon compound and at least one thermosetting plastic or of an inorganic polymer matrix.

As a result of superficially coating the granulated glass of the invention with an organic silicon compound and a thermosetting plastic or with an inorganic polymer matrix, the fracture toughness of the granulated glass is considerably increased, possibly existing microcracks are efficiently closed and the various glass grains are thus prevented from breaking apart. Thanks to the special protective layer, the granulated glass of the invention has a uniform Moh's hardness of about 6 and accordingly exhibits a high mechanical stability and hardly shatters. Moreover, the granulated glass of the invention has a considerably enhanced alkaline resistance over current alkaline silicate glass. Even after inclusion of the granulated glass in concrete for several months, no alkali-induced change in the surface of the granulated glass was observed.

The protective layer compensates for the different mechanical property values of glasses of different origins and compositions, thus providing uniform conditions for further processing and machining thereof.

The protective layer may be comprised of one or several layers. This means that organic silicon compound and thermosetting plastic may be provided either in one common layer or in separate layers. If the protective layer consists of an inorganic polymer matrix, it generally is single-layered meaning, it is formed without organic silicon compound.

The organic silicon compound preferably utilized is a compound having the general formula

Y—(CH₂)ₙ SiX₃

wherein X is a halogen atom such as fluorine, chlorine, bromine, and iodine or an alkoxy group with 1 to 20 carbon atoms, Y is an amino-, carboxy, cyano, methacryloxy, epoxy, mercapto or a possibly alkyl, aryl or aralkyl substituted vinyl group and n is a number from 0 to 30, more specifically from 0 to 10.

Such type organo functional silanes are known as bonding agents. In the present invention, they perform the function of a bonding agent and ensure a durable bond between glass and thermosetting plastic on the one side. On the other side, they serve, in conjunction with thermosetting plastics, as an alkali resistant, pore closing substance by means of which even the finest microcracks in the glass may be durably closed.

The manufacturing and properties of organic silicon compounds that may be utilized in accordance with the invention are described in “Ullmanns Enzyklopädie der technischen Chemie” (“Ullmann's Encyclopedia of Industrial Chemistry”) (4^{th} Ed.), vol. 21, pp. 498-499.

Thermosetting plastics suited for the invention are all the plastic materials made of curable resins such as epoxy resins, unsaturated polyester resins, diallyl phthalate resins, urea-formaldehyde resins, melamine-formaldehyde resins, melamine phenol-formaldehyde resins, polyurethanes, pre-polymers and phenol-formaldehyde resins. Epoxy resins, more specifically such based on bisphenol A or bisphenol A/F, and polyurethane are preferably utilized.

Inorganic polymers that are suited in accordance with the invention are all the structures made of curable inorganic binders such as water glasses, monoaluminum phosphate (refractory binder) or ceramic raw material. The inorganic polymers of preference are water glasses and monoaluminum phosphate.

The thermosetting plastics used in the coating of the invention preferably comply with DIN standard 7724 (supplement 2/1972).

The same comment applies for inorganic polymer structures or bonds respectively.

Any form of thermosetting plastics may be utilized, for example molded plastics, casting resins, adhesive resins or lac resins. The thermosetting plastics are preferably utilized in the form of lacs.

The manufacturing and properties of the thermosetting plastics are generally known and are described for example in Bauer, Woebcken “Verarbeitung duroplastischer Formmassen” (The Processing of Thermosetting Molding Materials), Munich, Hanser Verlag, 1973; “Physik der Duroplaste und anderer Polymerer” (Physics of Thermosetting Plastics and other Polymers), Darmstadt, Steinkopf, 1978; Saechtling “Kunststoff-Taschenbuch” (Plastics Pocket Book), 23. ed.; pp. 2-5, pp. 378-443, Munich, Hanser Verlag 1986; “Ullmanns Enzyklopädie der technischen Chemie” (“Ullmann's Encyclopedia of Industrial Chemistry”) (4^{th} Ed.), 15, 309-335, 477-481 and Woebcken “Duroplaste, Kunststoff-Handbuch” (Thermosetting Plastics, Plastic Material Pocket Book), 2^{nd} Ed., vol. 10, Munich-Vienna: Hanser Verlag, 1988.

The same comment applies to water glass and monoaluminum phosphate.

The application of the superficial encapsulation may be accomplished by applying for example an organic or aqueous solution of the organic silicon compound onto the surface of the glass and by subsequently overcoating this solution with a varnish made of thermosetting resin.

Depending on the intended purpose of utilization of the granulated glass, the silane component may be dispensed with. This more specifically applies to a protective layer built from an inorganic binder.

The process can be performed both with cold or with temperature equalized granulated glass.

The coating of the granulated glass with

I) the silane/thermosetting plastic system

II) the inorganic binder will be described hereinafter by way of example:

I) Coating with a silane/thermosetting plastic system

Step 1: Pretreatment of the granulated glass with silane

The silane may be utilized in the followings forms:

a) in pure form

b) in the aqueous medium

c) in a solvent

to b): the silane is preferably dissolved in water or in a mixture of water and a solvent (e.g., alcohol) by acid or alkaline catalytic hydrolysis.

Active concentration of silane:

0-10% by weight, preferably: 0.1-5.0% by weight.

to c): the silane is dissolved in alcohols, ketones, esters or hydrocarbons.

Active concentration of silane:

0-20% by weight, preferably: 1-5% by weight.

Application of silane: The silane may be applied (in the variations a to c) onto the granulated glass by spraying, pouring, dripping, intensively mixing (grinding and mixing) it in a compulsory mixer.

After sufficient mixing/grinding and mixing, a drying procedure is performed which is complete when the granulated glass is adhesion-free and does not react with test chemicals.

Step 2: C ating f the silane pretreated granulated glass

For coating the silane pretreated granulated glass, the following thermosetting plastic systems are preferably suited:

a) 2-component epoxy: curing occurs by mixing epoxy resin (component A) with an amine hardener (component B)

How to proceed: The components A and B are premixed at room temperature prior to being added to the granulated glass with strong mixing. The coating procedure is complete when the granulated glass is adhesion-free.

2-component and/or 1-component urethane:

Curing is achieved by mixing polyol and diisocyanate or by coating with prepolymer isocyanate.

How to proceed: in the same way as in a)

c) acrylate: Curing is achieved by mixing acrylate resin (component and free radical curing agent (component B) or by UV-radiation (without free radical curing agent)

How to proceed:

Using acrylate/free radical curing agent, like a). For UV curing: the acrylate is added with intensive stirring to the granulated glass (at room temperature). After the acrylate has been homogeneously distributed, the granulated glass is UV irradiated with intensive stirring. The procedure is complete when the granulated glass is adhesion-free.

d) Polyester Curing is achieved by mixing polyester resin with a free radical curing agent or by UV irradiation.

How to proceed: like in c)

Achievable c ating thicknesses d: depend on the grain size of the granulated glass and on the quantity of thermosetting plastic system added:

d=up to 200 μm

Also, organic silicon compound can first be mixed in a suited solvent with thermosetting resin prior to being applied to the surface of the glass.

The amount of silane that is added to the thermosetting plastic system preferably ranges from 1 to 10% by weight.

The coating is performed as described herein above (step 2 a-d).

Preferably, the organic silicon compound and the thermosetting plastic are matched. Particularly preferred combinations of an organic silicon compound (A) of the general formula Y—(CH₂)ₙ SiX₃, wherein Y, n and X have the meaning given herein above, and a thermosetting plastic (B) are listed as follows:

silicon compound A with Y=amino or epoxy, mercapto group combined with an epoxy-resin matrix employed as the thermosetting plastic (B)

silicon compound A with Y=acrylate, methacrylate, vinyl group combined with a polyester matrix, acrylate matrix and/or vinylester matrix employed as the thermosetting plastic (B)

silicon compound A with Y=amino, epoxy, mercapto group combined with an urethane or an isocyanate matrix employed as the thermosetting plastic (B).

A particularly durable, irreversible bond is thus achieved between the top surface of the glass and the protective layer.

II) Coating and coloring with alkali water glass employed as an inorganic binder

Sodium and/or potassium water glasses are preferably suited for coating the granulated glass.

How to Proceed:

The granulated glass is intensively mixed (mixed and grinded) with the water glass at room temperature using a compulsory mixer. The water glass may be added by spraying, pouring or dripping. After homogeneous wetting has been performed, an inorganic powder pigment is added and homogeneously distributed over the top surface of the granulated glass to color the granulated glass utilized. In an alternative coloring method, the water glass may also be blended directly with the pigment powder prior to being added to the granulated glass. To fixate and configure the colored inorganic polymer matrix, the water glass is baked at temperatures ranging from 300 to 1000.degree.C. (preferably from 650 to 950.degree.C.). Directly heated revolving tubular kilns are suited for this purpose.

As a result thereof, an irreversibly deposited protective layer is obtained which is characterized by its color constancy at high temperatures (300 to 500.degree.C.).

In accordance with a preferred embodiment of the invention, the outer surface of the coating is configured to be granular so as to enhance the adherence of the subsequent binders or mixtures.

The granulated glass used may be of any glass such as soda-lime silicate glass, borosilicate glass, quartz glass, technical glass, window glass, bottle glass, opal glass, industrial glass, stained glass, crystal glass, fiber glass, foam glass, composite glass, optical crown or flint and these glasses may be of any color and used in any combination.

The term “glass” is to be construed herein as very general inorganic substances in the amorphous, non crystalline solid state. The purity and composition of the granulated glass utilized in accordance with the invention do not matter; an important aspect of the invention rather is that granulated glass of any kind may be given uniform high fracture toughness and alkaline resistance by silanating and coating it with a thermosetting plastic or an inorganic polymer matrix in accordance with the invention. Accordingly, recycled glass, which is available at low cost, may also be utilized.

Clear glass is preferably used.

The granulated glass preferably has a mean diameter between 0.5 and 64 mm, more specifically between 1 and 32 mm.

The manufacturing, compositions and properties of the various types of glasses are generally known and described for example in “Kirk-Othmer” (3^{rd} ed.), vol. 11, pp. 807-880; “Ullmanns Enzyklopädie der technischen Chemie” (“Ullmann's Encyclopedia of Industrial Chemistry”) (4^{th} Ed.), vol 12, pp. 317-366.

If, according to the preferred embodiment, the granulated glass is made of clear glass, specific optical effects may be achieved with a colored protective layer. Said protective layer may be colored by adding a suited colorant to the organic silicon compound, the thermosetting plastic or the inorganic binder. Colorants suited to color the protective layer are pigment powder and paste of organic and inorganic origin.

The coloring process described herein above imparts the optical effect of transparent glass exhibiting uniform coloration throughout. This effect lasts even if the colored protective layer is partially removed from the top surface of the granulated glass. In this event, the color of the remaining regions that are still coated with the colored protective layer shines through, thereby giving the impression the entire glass particle has been colored throughout. This means that the granulated glass of the invention, which is provided with an accordingly colored protective layer, gives the impression of a glass exhibiting uniform coloration throughout even after portions of the protective layer have been grinded or blasted off. The advantage of granulated glass coated with a colored protective layer is that it is much more affordable than granulated glass that has been colored throughout.

The high fracture toughness and excellent alkaline resistance of the granulated glass make it suited for use as an aggregate in building material structures or coverings.

The granulated glass of the invention is more specifically suited for use in building material structures or coverings that are joined by mineral/inorganic binding agents.

Moreover, the granulated glass colored with an inorganic binder is particularly suited for use in asphalt coverings as it additionally exhibits high temperature stability (color constancy at high temperatures, preferably between 300 and 500.degree.C.).

Eventually, as the granulated glass of the invention exhibits high fracture toughness and a poor tendency to shatter, it may also be used as a gliding material for sporting events and event performances. Combined with suited gliding agents, the granulated glass of the invention could for example also be utilized as “artificial snow” for skiing and snowboarding events.

The invention will be understood better upon reading the description of an exemplary embodiment:

15 kg of granulated glass made of alkali silicate glass with a mean particle size of between 0 and 4 mm were placed in a drum mixer and blended at room temperature with a mixture of 0.45 kg of thermosetting plastic (epoxy resin+hardener) and 0.045 kg of an epoxy corresponding silane, by intensively mixing them. After homogeneously wetting the granulated glass used, 0.1 kg of an inorganic color pigment powder was added with intensive mixing. After the color pigment was homogeneously distributed, stirring was continued at room temperature until the granulated glass was adhesion-free.

The term “granulated glass” is to be construed as any particle, piece or small piece of glass of any origin and production, more specifically glass beads, roving segments, glass fibers, glass drops, fractions of larger glass structures, and so on.

1. Granulated glass that is superficially coated with a protective layer, said protective layer containing at least one organic silicon compound and at least one thermosetting plastic or at least one inorganic polymer matrix.

2. The granulated glass according to claim 1, characterized in that the organic silicon compound is a compound of the general formula
Y—(CH₂)ₙ SiX₃
wherein X is a halogen atom such as fluorine, chlorine, bromine, and iodine or an alkoxy group with 1 to 20 carbon atoms, Y is an amino-, carboxy, cyano, methacryloxy, epoxy, mercapto or a possibly alkyl, aryl or aralkyl substituted vinyl group and n is a number from 0 to 30, more specifically from 0 to 10.

3. The granulated glass according to claim 1 or 2, characterized in that the thermosetting plastic is a diallyl phthalate resin, an epoxy resin, an urea-formaldehyde resin, a melamine-formaldehyde resin, a melamine phenol-formaldehyde resin, a phenol-formaldehyde resin or an unsaturated polyester resin.

4. The granulated glass according to claim 3, characterized in that the epoxy resin is a bisphenol-A/bisphenol-A/F based epoxy resin varnish.

5. The granulated glass according to claim 1, characterized in that the inorganic polymer matrix consists of water glass, monoaluminum phosphate or of ceramic raw materials.

6. The granulated glass according to one of the afore mentioned claims, characterized in that the glass substantially consists of clear glass and that the coating is colored.

7. The granulated glass according to one of the afore mentioned claims, characterized in that the colored glass exhibits color constancy at temperatures above 300.degree.C.

8. The granulated glass according to one of the afore mentioned claims, characterized in that the glass particles contain recycled glass.

9. The granulated glass according to one of the afore mentioned claims, characterized in that the glass particles have a mean diameter between 0.5 and 64 mm, more specifically between 1 and 32 mm.

10. Use of granulated glass according to one of the claims 1 through 7 as a gliding means for sporting events and event performances.
